(19) United States
(12) Patent Application Publication
(10) Pub. No.: US 2015/0089871 A1
(43) Pub. Date: Apr. 2, 2015

(54) Container For Growing And Displaying A Nursery Item

(71) Applicant: Stephen Gould Corporation, Whippany, NJ (US)

(72) Inventor: Matthew Anderson, Chester, NJ (US)

(21) Appl. No.: 14/044,560

(22) Filed: Oct. 2, 2013

(51) Int. Cl. A01G 9/02

(52) U.S. Cl. CPC A01G 9/02
USPC 47/65.5

(57) ABSTRACT

A container assembly for displaying plants and other nursery items. The container assembly including a lower container portion for containing a plant for growing and having a container wall with an open top end. The container wall includes at least two mounting flanges extending laterally from the wall. An upper display portion with an upper wall substantially circumscribes the top of the container wall. At least a portion of the upper wall includes a substantially transparent or translucent portion so as to permit light to pass through the upper wall to facilitate growing of a plant contained within the lower container portion. Mounting slots are formed in the upper wall for receiving the mounting flanges. A hanging tab is formed on or attached to the upper wall and extends upward from a portion of the upper wall for retaining the container assembly on a display.

### FIELD OF THE INVENTION

The present invention related to growing containers for plants and other nursery items and, more particularly, to a growing container that is also useful in displaying such products.

### BACKGROUND

Most nursery plants are grown in conventional container pots from seed. These plants are typically displayed in a crate that holds multiple container pots. Larger plants are typically placed in larger containers and displayed simply by placing the container on a counter top or hanging the plant with a hook.

A need exists for a more versatile container assembly which permits a plant contained in a container pot to grow while still displaying the product for potential purchasers to view, and at the same time protecting the plant from damage.

### SUMMARY OF THE INVENTION

The present invention related to a container assembly for displaying plants and other nursery items. The container assembly includes a lower container portion for containing a plant for growing. The lower container portion includes a container wall which defines a cavity within the confines of the container wall. The upper end of the wall is open so as to define an open top for permitting access to the cavity. The container wall includes at least two mounting flanges extending laterally from the wall.

The container assembly also includes an upper display portion with an upper wall that substantially circumscribes the top of the container wall. At least a portion of the upper wall includes a substantially transparent or translucent portion so as to permit light to pass through the upper wall to facilitate growing of a plant contained within the lower container portion. Mounting slots are formed in the upper wall for receiving the mounting flanges on the lower container portion. Each slot is located proximate to but spaced apart from a lower edge of the upper wall. The slots have a width that is slightly wider than the width of a corresponding mounting flange. Each mounting flange on the lower container portion extends through a slot in the upper wall so as to secure or attach the upper display portion to the lower container portion.

A hanging tab is formed on or attached to the upper wall and extends upward from a portion of the upper wall. The hanging tab includes a display attachment for retaining the container assembly on a display.

The container wall is preferably frustoconical in shape and includes a closed bottom that is formed integral with a lower edge of the wall.

Each mounting flange preferably includes a retention protrusion that extends downward from the flange.

The upper wall may be made from a single piece of material that is folded to form wall sections, with at least one end of the upper wall including an extension that is folded so as to overlie and attach to a portion of the other end of the upper wall to thereby form a single enclosure with an open top and bottom.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive

### BRIEF DESCRIPTION OF THE DRAWINGS

For the purpose of illustrating the invention, there are shown in the drawings embodiments that are presently preferred, it being understood, however, that this invention is not limited to the precise arrangements and constructions particularly shown.

FIG. 1 is a perspective view of a container assembly according to an embodiment of the invention.

FIG. 2 is a front view of the container assembly of FIG. 1.

FIG. 3 is a cross-sectional view of the container assembly of FIG. 1, taken along lines 2-2 in FIG. 1.

FIG. 4 is a side view of the container assembly of FIG. 1.

FIG. 5 is a bottom view of the container assembly of FIG. 1.

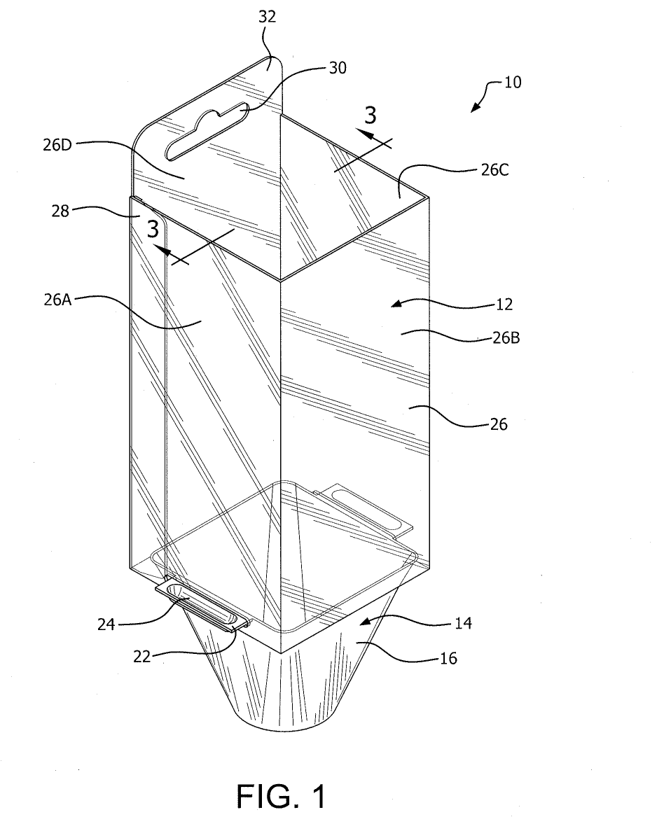

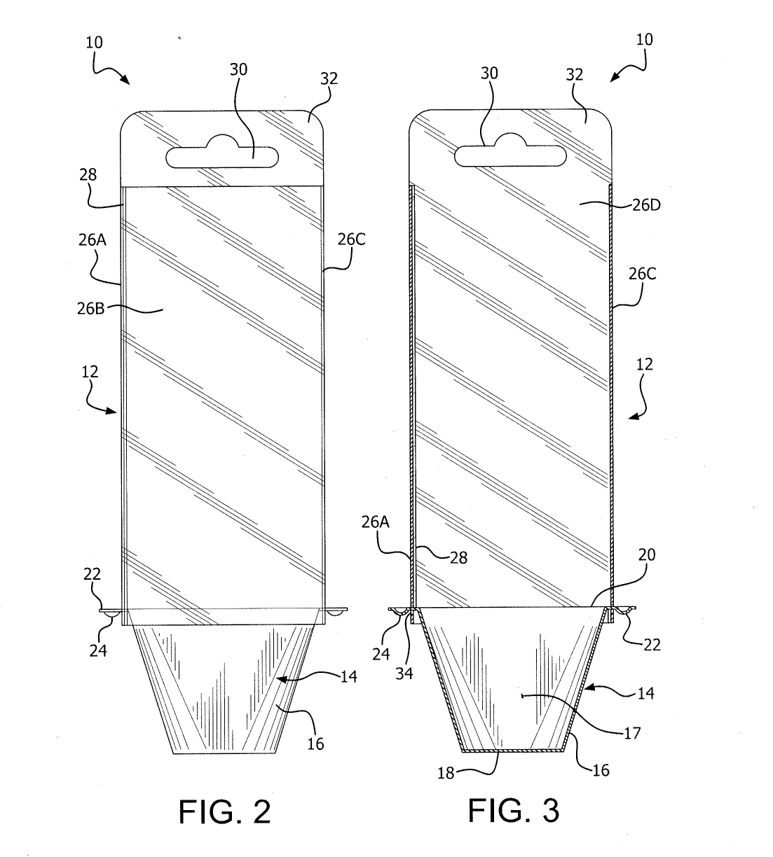

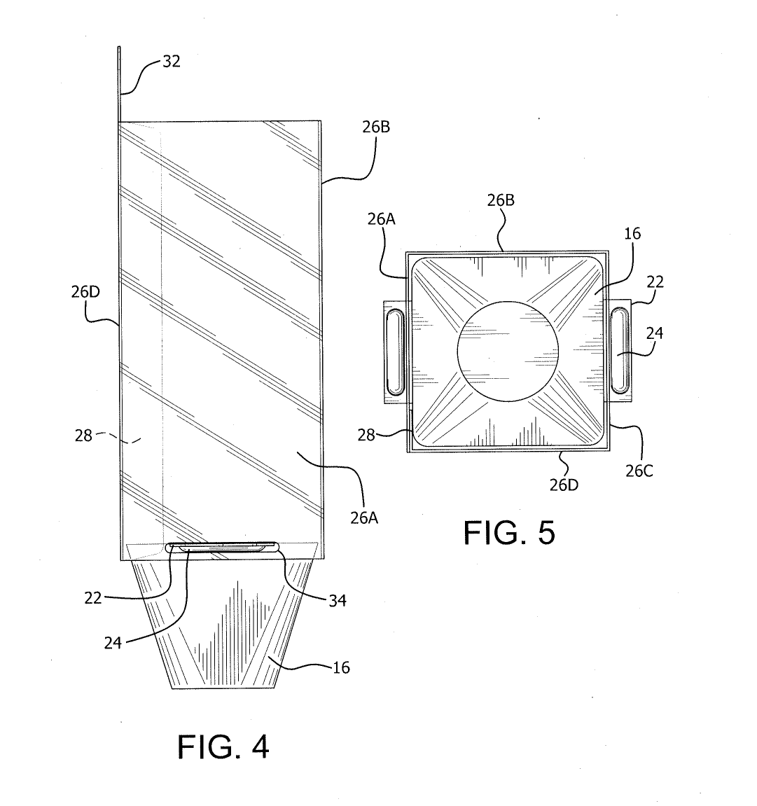

### DETAILED DESCRIPTION OF THE PREFERRED EMBODIMENTS

Referring now to the figures, an embodiment of a container assembly 1 for displaying plants is shown. The container assembly 10 includes an upper display portion 12 and a lower container portion 14. The lower container portion 14 includes a container wall 16 which is preferably tapered and defines a cavity 17 within the confines of the wall 16. The wall 16 is preferably frustoconical in shape, but could also be any other suitable shape, for containing a plant, such as square or cylindrical in shape, with straight or tapered walls. A bottom 18 is preferably formed integral with the lower end of the wall 16. The upper end of the wall 16 preferably is open so as to define an open top 20 for permitting access to the cavity 17.

Preferably the lower container portion is configured to contain a plant for growing, either from seed or as a transplant. As such, the lower container portion 14 is preferably made from any suitable material capable of holding and sustaining a growing plant, such as plastic material. In one embodiment, the lower container portion is made from 0.025 high impact polystyrene, with an extra rubber additive. The lower container portion may be made using any conventional process, such as injection molding, thermoforming process or vacuum forming. In one preferred embodiment, the lower container portion is vacuum formed and die cut so as to form a top flange having square sides that measure approximately 2 inches. While the lower container portion 14 in the illustrated embodiment includes a bottom 18, it is also contemplated that the lower container portion 14 may be formed without a bottom and, instead, a separate container with the plant can be slid into the lower container portion 14 through the open top. In such an embodiment, the wall 16 would be shaped and designed to capture and hold a separate growing container.

The wall preferably has at least two mounting flanges 22 extending laterally from the wall 16, preferably at the top 20. As will be discussed in more detail below, the mounting flanges 22 are designed to secure or attach the upper container portion 12 to the lower container portion 14. Each mounting flange 22 may include a retention protrusion or projection 24 that extends downward.

The upper display portion 12 preferably includes a upper wall 26 which preferably circumscribes the top 20 of the container wall 16. The shape of the upper wall 26 need not be the same shape as the container wall 16 of the lower container portion 14. In the illustrated embodiment, the upper wall 26 is substantially square in shape with four wall sections 26A-26D. The top edge 20 of the container wall 16 on the lower container portion 14 is shown molded with a substantially complementary square shape, however that need not be the case.

The upper wall 26 is preferably made from a single piece of material that is preferably transparent or translucent so as to permit light to pass through the upper wall 26 to a plant contained inside. It should be readily apparent that the upper wall 26 could be formed with separate wall sections 26A-26D that are attached to one another, with only a part of one or more wall sections being transparent or translucent. The upper wall 26 is preferably made from 12 mil PET material and, in one embodiment, the wall sections each measure about 2 inches wide by about 2 inches deep, and has a height of about 4.5 inches. It is contemplated that portions of the upper wall 26 may include graphics, text or other markings for marketing or instructional purposes.

As noted above, the upper wall 26 in the illustrated embodiment is made from a single sheet of material that is folded in three places to form the wall sections 26A 26D. At least one wall section 26D includes a lateral extension or tab 28 that is folded so as to overlie a portion of wall section 26A. The extension 28 is attached to the free side edge of the wall section 26A, thereby securing wall section 26A to wall section 26D and, thus, forming a continuous walled enclosure with an open top and bottom. The tab 28 and wall section 26A are preferably attached using any conventional method, such as ultrasonic bonding, adhesive, crimping, etc. Also, also described above, while the illustrated embodiment depicts an upper wall 26 formed from a single sheet of material, it should be readily apparent that the upper wall can be formed from more than one piece of material and in any desired shape.

The upper wall 26 preferably includes a display attachment 30. More specifically, in the illustrated embodiment, the upper wall section 26D also includes a hanging tab 32 that projects upward from the top edge of the wall section 260. The hanging tab 32 is preferably an extension of the wall section 26D, although it is contemplated that the hanging tab 32 may be a separate component that is attached to the wall section 26D. In one embodiment, the hanging tab extends upward about 1.125 inches. The display attachment 30 is preferably a hole or slot formed in the hanging tab 32 and sized and/or shaped to engage a display bracket (not shown) used for holding products for display. Those skilled in the art would be readily capable of incorporating other hanging mechanisms into the container assembly 10.

The upper display portion 12 preferably includes at least a complementary number of mounting slots or slits 34 for receiving the mounting flanges 22. More particularly, and with reference to the exemplary embodiment shown, at least some of the upper wall sections 26A-26D include a mounting slot 34 proximate to but spaced apart from a lower edge of the upper wall. Each slot 34 has a width that is slightly wider than the width of a corresponding mounting flange 22 on the lower container portion 14. The slot 34 also preferably has a height that is substantially the same as or slightly larger than the height of the projection 24. As such, the mounting flange 22 can readily pass through the slot 34 in a wall section. Although the figures illustrate that the slots 34 have a vertical height or spacing, it should be readily apparent that the slots 34 can be slits formed in the upper wall and through which the mounting flange and protrusion are inserted.

In the illustrated embodiment, there are two mounting flanges 22 extending from opposition sides of the lower container portion 14 and two corresponding mounting slots 34 formed in the upper display portion 12. The mounting flanges 22 extend through the mounting slots 34 so as to position the projections 24 on the outside of the upper wall section (wall sections 26A and 26C in the illustrated embodiment. Thus, the projections 24 inhibit the mounting flange 22 from passing through the mounting slot 34 when the display container assembly 10 is hanging on the hanging tab 32.

One of the benefits of present invention is the ability for the upper display portion to be removed by the end user from the lower container portion, and permit the lower container port to continue to be used as a growing container.

The present invention may be embodied in other specific forms without departing from the spirit or essential attributes thereof and, accordingly, reference should be made to the appended claims, rather than to the foregoing specification, indicating the scope of the invention.

1. A container assembly for displaying plants and other nursery items, the container assembly comprising:
a lower container portion for containing plant for growing, the lower container portion including a container wall which defines a cavity within the confines of the container wall, the upper end of the wall is open so as to define an open top for permitting access to the cavity, the container wall includes at least two mounting flanges extending laterally from the wall; and
an display portion including an upper wall which substantially circumscribes the top of the container wall, at least a portion of the upper wall includes a substantially transparent or translucent portion so as to permit light to pass through the upper wall, at least a complementary number of mounting slots to the mounting flanges on the lower container portion are formed through the upper wall, each slot being located proximate to but spaced apart from a lower edge of the upper wall, and having a width that is slightly wider than the width of a corresponding mounting flange, and a hanging tab on the upper wall and extending upward from a portion of the upper wall, the hanging tab including a display attachment for retaining the container assembly on a display,
wherein each mounting flange on the lower container portion extends through a slot in the upper wall so as to secure or attach the upper display portion to the lower container portion.

2. A container assembly according to claim 1, wherein container wall is preferably frustoconical in shape with a tapered container wall.

3. A container assembly according to claim 2, wherein lower container portion includes a bottom that is formed integral with a lower edge of the wall.

4. A container assembly according to claim 3, wherein lower container portion is made from polystyrene material having a thickness of approximately 0.025 inches.

5. A container assembly according to claim 3, wherein each mounting flange includes a retention protrusion that extends downward from the flange, and wherein each slot in the upper wall has a height that is at least substantially the same as than the height of the projection.

6. A container assembly according to claim 3, wherein the upper wall is substantially square in shape with four wall sections.

7. A container assembly according to claim 6, wherein the upper wall is made from a single piece of material that is folded to form wall sections, with at least one end of the upper wall including an extension that is folded so as to overlie and attach to a portion of the other end of the upper wall to thereby form a single enclosure with an open top and bottom.

8. A container assembly according to claim 7, wherein the upper wall is made from 12 mil PET material.

9. A container assembly according to claim 7, wherein the extension is attached to the wall through ultrasonic bonding, adhesion, or crimping.

10. A container assembly according to claim 7, wherein the hanging tab is formed integral with and is an extension of a portion of the upper wall.

11. A container assembly for displaying plants and other nursery items, the container assembly comprising:
a lower container portion for containing a plant for growing, the lower container portion including a container wall which defines a cavity within the confines of the container wall, the upper end of the wall is open so as to define an open top for permitting access to the cavity, the container wall includes at least two mounting flanges extending laterally from the wall; and
an upper display portion including an upper wall which substantially circumscribes the top of the container wall, at least a portion of the upper wall is substantially transparent or translucent portion so as to permit light to pass through the upper wall, at least a complementary number of mounting slots to the mounting flanges on the lower container portion are formed through the upper wall, each slot being located proximate to but spaced apart from a lower edge of the upper wall, and having a width that is slightly wider than the width of a corresponding mounting flange, and a hanging tab formed integral with the upper wall and extending upward from a portion of the upper wall, the hanging tab including a slot or hole formed in or attached to the hanging tab for retaining the container assembly on a display, the upper wall being made from a single piece of material that is folded to form individual wall sections, with at least one end of the upper wall including an extension that is folded so as to overlie and attach to a portion of the other end of the upper wall thereby forming a single enclosure with an open top and bottom,
wherein each mounting flange on the lower container portion extends through a slot in the upper wall so as to secure or attach the upper display portion to the lower container portion.

12. A container assembly according to claim 11, wherein each mounting flange includes a retention protrusion that extends downward from the flange, and wherein each slot in the upper wall has a height that is at least substantially the same as than the height of the projection.

13. A container assembly according to claim 12, wherein the upper wall is folded so as to form a substantially square shape with four wall sections.

14. A container assembly according to claim 12, wherein the extension is attached to the wall through ultrasonic bonding, adhesion, or crimping.

15. A container assembly according to claim 14, wherein container wall is preferably frustoconical in shape with a tapered container wall.

16. A container assembly according to claim 15, wherein lower container portion includes a bottom that is formed integral with a lower edge of the wall.

17. A container assembly according to claim 16, wherein lower container portion is made from polystyrene material having a thickness of approximately 0.025 inches.
